(19) United States
(12) Patent Application Publication
(10) Pub. No.: US 2018/0118104 A1
(43) Pub. Date: May 3, 2018

(54) BENT LIGHT GUIDE

(71) Applicant: Valeo Vision, Bobigny Cedex (FR)

(72) Inventors: Remi Letoumelin, Bobigny Cedex (FR); Pierre-Louis Tassy, Bobigny Cedex (FR)

(73) Assignee: Valeo Vision, Bobigny Cedex (FR)

(21) Appl. No.: 15/794,055

(22) Filed: Oct. 26, 2017

(30) Foreign Application Priority Data
Oct. 28, 2016 (FR) 16 60528

(51) Int. Cl. B60Q 3/66; F21V 8/00; B60Q 1/32

(52) U.S. Cl. CPC B60Q 3/66; G02B 2006/12119; B60Q 1/32; G02B 6/0001

(57) ABSTRACT

Light guide for a lighting module, notably for a motor vehicle. The light guide is designed to guide light emanating from a light source within it. The light guide includes a bent inlet portion intended to be optically coupled to the light source for injecting light into the light guide. An outlet portion is optically coupled to the inlet portion and designed to radiate all or some of the light injected into the light guide. The inlet portion has an optical element configured to radiate part of the light passing into the inlet portion.

The invention relates to the field of light guides, particularly light guides used to illuminate the interior of motor vehicles.

In order to improve the illumination of motor vehicle interiors, it is known practice to fit certain items of interior equipment with light-emitting devices.

One of the current trends for achieving this relies on the use of light guides optically connected to a light source by one of their ends, and simultaneously propagating light within the light guide and causing some of the light to radiate in a chosen direction so as to generate a large-sized apparent lighting surface, for example to back-light a chosen surface.

This makes it possible to obtain significant brightness at low cost, while at the same time limiting the associated electrical power consumption by comparison with more conventional lighting devices, for example using light bulbs.

However, this type of light-guide device may be subject to certain constraints which tend to reduce its effectiveness and to impair the overall appearance of the lighting effect obtained.

Specifically, the space that can be allocated to these devices is generally itself highly constrained. This tends to result in a spatial configuration of the light guides in which the guides have a portion ill-suited to radiating in the desired direction, such as, for example, an inlet portion optically connecting a light source that injects light into the guide and an outlet portion of the guide via which the light is radiated.

Now, the presence of this portion that is ill-suited to radiating in the desired direction results in the presence of undesirable dark regions within the resultant lighting surface.

So, the invention seeks to improve the situation.

To this end, the invention relates to a light guide for a lighting module, notably for a motor vehicle, the light guide being designed to guide light emanating from a light source within it, and comprising:
a bent inlet portion intended to be optically coupled to said light source for injecting light into the light guide,
an outlet portion optically coupled to the inlet portion and designed to radiate all or some of the light injected into the light guide,
   characterized in that the inlet portion comprises an optical element configured to radiate part of the light passing into the inlet portion.

The guiding of light within the guide advantageously relies on total internal reflections of the light off the internal surfaces of the guide.

Furthermore, the inlet portion advantageously comprises an injection first sub-portion and a connection second sub-portion which are optically connected to one another.

Moreover, the inlet and outlet portions are advantageously consecutive.

Furthermore, the outlet portion is advantageously provided with one or more decoupling elements, the or each decoupling element being designed to decouple out of the guide light that is incident upon this decoupling element.

According to one aspect of the invention, the inlet portion has an overall shape bent at 90°, or has a sub-portion having an overall shape bent at 90°.

According to one aspect of the invention, the outlet portion is configured to radiate light in at least one favored overall direction of emission, the optical element being configured to emit light in a favored direction of emission parallel to said favored overall direction of emission.

According to one aspect of the invention, the optical element is arranged on the inlet portion at a suitable location such that the light emanating from the light source and entering the optical element undergoes at least one reflection within the light guide.

According to one aspect of the invention, the optical element has a reflection face configured to reflect at least part of the light that enters the optical element.

According to one aspect of the invention, the reflection face is curved.

According to one aspect of the invention, the reflection face has the overall shape of a portion of the external surface of a torus.

According to one aspect of the invention, the optical element has a base of right prismatic or frustoconical overall shape comprising a portion configured to exhibit a shape that complements a surface of the inlet portion at which the optical element is arranged.

According to one aspect of the invention, the optical element is made from a material having an optical index substantially identical to the optical index of the inlet portion.

According to one aspect of the invention, the optical element is formed as one with the inlet portion.

According to one aspect of the invention, the optical element is fixed to the inlet portion.

According to one aspect of the invention, the outlet portion comprises deflection means configured to decouple some of the light spreading in the outlet portion for the radiation of said outlet portion.

Advantageously, the deflection means comprise decoupling elements configured to decouple at least some of the light spreading in the main portion as far as them out of the main portion. Each decoupling element of the outlet portion is designed to decouple light in such a way as to respectively form on a surface that is to be illuminated an illuminated region of given width along the outlet portion, the decoupling elements being arranged in such a way that the illuminated regions are contiguous and/or overlap one another.

Advantageously, the optical element is also arranged in such a way as to decouple light so as to form on this surface an illuminated region of a width greater than the widths of the decoupling elements.

The invention also relates to a lighting module for illuminating the inside of a motor vehicle interior, the lighting module comprising:
a light guide as defined hereinabove, and
a light source optically coupled to the inlet portion of the light guide.

The invention also relates to an instrument panel, notably of a motor vehicle, the instrument panel comprising a cavity, a surface and a lighting module as defined hereinabove arranged at least in part in the cavity and configured to illuminate said surface.

The cavity allows the surface to be back-lit by the lighting module. For example, to this end, it is open toward the surface.

The cavity may be delimited by a front wall configured to form a masking panel masking the elements of the lighting module that are situated in the cavity from an individual located inside the vehicle interior.

The invention will be better understood from reading the detailed description which follows, given solely by way of example and with reference to the attached figures, in which:

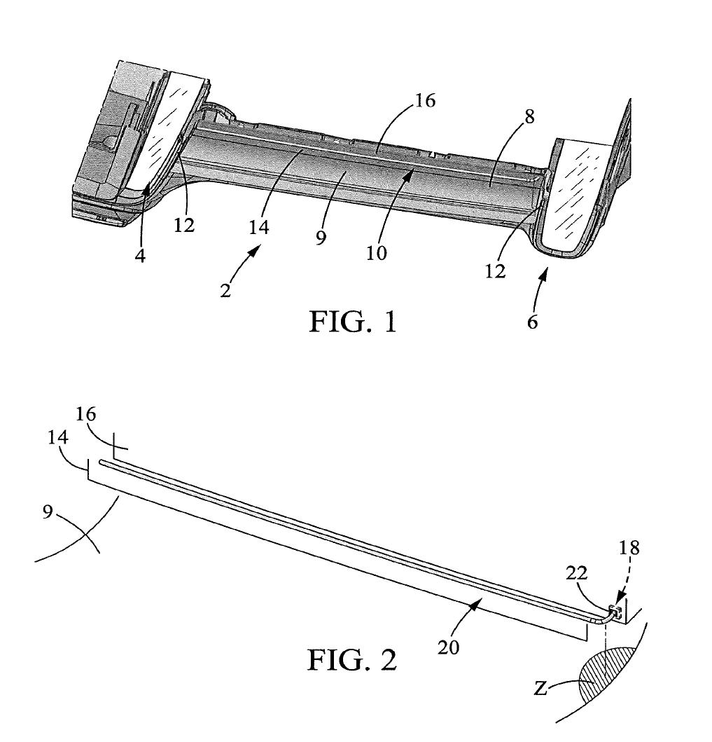

FIG. 1 is a schematic illustration of an instrument panel according to the invention;

FIG. 2 illustrates a lighting module for illuminating the instrument panel of FIG. 1;

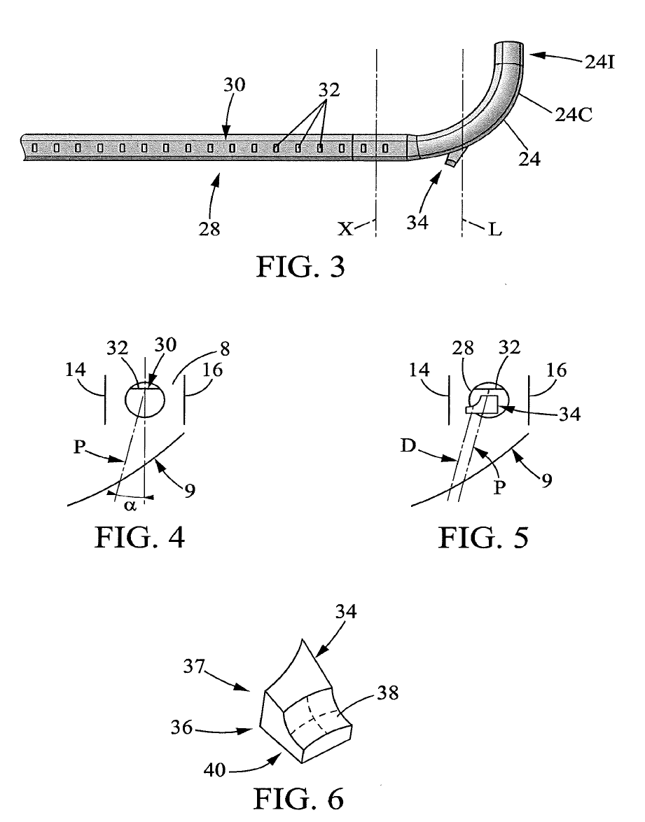

FIG. 3 illustrates a light guide of the lighting module of FIG. 2;

FIG. 4 illustrates a view in cross section of an outlet portion of the light guide of FIG. 3;

FIG. 5 illustrates a view in section of an optical element of the outlet portion of FIG. 4;

FIG. 6 illustrates the optical element of FIG. 5.

FIG. 1 illustrates an instrument panel 2 according to the invention, hereinafter referred to as panel 2. The panel 2 is intended to be arranged in a motor vehicle interior. The panel 2 defines a support in, on or across which vehicle equipment is intended to be arranged.

In particular, the panel 2 comprises two ventilation orifices 4, 6 forming an air inlet and/or outlet via which the vehicle interior fluidically communicates with the outside of the vehicle and/or with vehicle ventilation equipment.

Furthermore, the panel 2 comprises a cavity 8, a surface 9 intended to be illuminated and a lighting module 10 arranged in the cavity 8.

The cavity 8 is configured to accommodate the lighting module 10 in full or in part.

The cavity 8 overhangs the surface 9. Furthermore, the cavity 8 is open toward the surface 9. Because of this it allows the surface 9 to be back-lit by the lighting module 10, as described in greater detail hereinbelow.

The cavity 8 is laterally delimited by two walls 12 that also form the walls of the ventilation orifices 4, 6. It is furthermore delimited in the depthwise direction by a front wall 14 and a rear wall 16 (FIGS. 1 and 2).

The front wall 14 is configured to form a masking panel masking the elements of the lighting module 10 that are situated in the cavity from an individual located inside the vehicle interior. The rear wall 16 is configured to act as a support on which all or part of the lighting module 10 is fixed. Advantageously, the rear wall 16 is also configured to mask vehicle-interior equipment arranged behind it, such as connection elements.

The walls 14 and 16 are, for example, arranged substantially vertically (in the sense of the orientation of the vehicle). They are, for example, arranged substantially parallel to one another. Furthermore, they each extend between the two walls 12. They are, for example, fixed by their lateral ends to these walls 12.

The lighting module 10 is configured to illuminate the surface 9. More specifically, the lighting module 10 is advantageously configured to illuminate the surface 9 in such a way that the lighting effect obtained is spatially uniform across the entire width of the surface 9.

With reference to FIG. 2, the lighting module 10 comprises a light source 18 and a light guide 20, hereinafter referred to as guide 20.

The light source 18 is configured to generate light.

For example, the light source 18 comprises a light-emitting element (not depicted) and a substrate 22 on which the light-emitting element is arranged.

The light-emitting element is, for example, a light-emitting diode configured to generate light when electrically powered. For example, the light-emitting element is configured to generate white light.

The substrate 22 is configured to allow the light-emitting element to be electrically powered so that it generates light. The substrate 22 is, for example, fixed to the rear wall 16.

The guide 20 is configured to simultaneously guide light within it and radiate this light toward the surface 9. In particular, it is configured to illuminate the surface 9 in a way that is uniform across the entire width of the surface 9.

With reference to FIGS. 2 and 3, the guide 20 comprises an inlet portion 24 and an outlet portion 28. The inlet 24 and outlet 28 portions are consecutive.

The inlet portion 24 is configured to optically couple the light source 18 to the outlet portion 28. In other words, the inlet portion 24 is configured to cause the light emitted by the light source 18 to enter the guide 20 and to carry at least some of this light as far as the outlet portion 28.

To this end, the inlet portion 24 is optically coupled to the light source 18 at one of its ends. This coupling is, for example, achieved in a known way, for example by placing one end of the inlet portion and the source 18 facing one another.

Furthermore, it is optically coupled to the outlet portion 28 by its opposite end. For example, for this reason, the inlet portion 24 and the outlet portion 28 are formed as one with one another at this end. Alternatively, they are, for example, fixed to one another.

Furthermore, the inlet portion 24 is made from a material configured to allow light to propagate within it by total internal reflection at the interfaces between the light guide and the external environment.

For example, the inlet portion 24 is made of polymethylmethacrylate, known by the abbreviation PMMA, or alternatively from transparent polycarbonate PC.

The inlet portion 24 is not rectilinear. For example it is curved.

More specifically, it takes the overall form of a bend. For example, it comprises a sub-portion which has the overall shape of a 90° bend, or has such a shape itself This shape is suitable for allowing good optical connection of the outlet portion to the light source while at the same time taking into consideration constraints on size which apply to the lighting module 10 and which are the result of the presence of the ventilation orifices 4, 6 which cannot have components of the lighting module 10 installed within them.

For example, the inlet portion 24 comprises an injection first sub-portion 241 and a connection second sub-portion 24C optically connected to one another. These are advantageously formed as one.

The first sub-portion 241 is configured to optically connect the guide 20 to the light source 18. It has, for example, a cylindrical overall shape. It has, for example, a longitudinal dimension that is small in relation to the longitudinal dimension of the outlet portion 28.

The second sub-portion 24C is configured to optically connect the first sub-portion 241 to the outlet portion 28. It is interposed between these.

The second sub-portion 24C has a bent shape. For example, this sub-portion has the shape of a 90° bend.

For preference, these two sub-portions are made from the same material.

Still with references to FIGS. 2 and 3, the outlet portion 28 is configured to simultaneously guide within it the light that reaches it from the inlet portion and to emit at least some of this light toward the surface 9. This emission is the result here of light traveling within it being deflected or decoupled, as described hereinafter.

The outlet portion 28 comprises an end optically coupled to the inlet portion 24 and an opposite end. This opposite end is, for example, free. Alternatively, this end is fixed directly or indirectly to one of the walls 12.

The outlet portion 28 is made from a material configured to allow light to propagate within it and the rays of light propagating within it to reflect off at least part of its interfaces with the outside by total internal reflection.

For example, the outlet portion is made from polymethylmethacrylate, known by the abbreviation PMMA, or alternatively from transparent polycarbonate PC.

The outlet portion 28 is, for example, substantially rectilinear.

Advantageously, the inlet 24 and outlet 28 portions have respective optical indexes that are similar to one another. What is meant by an optical index that is “similar” is that the optical indexes are configured so that light passing from one portion to another is deflected little if at all. Advantageously, the respective optical indexes of these portions are substantially identical.

Furthermore, advantageously, the inlet 24 and outlet 28 portions are formed as one.

However, as an alternative, the portions are not formed as one and are joined together, for example by bonding or overmolding.

With reference to FIG. 4, which illustrates a view in cross section of the lighting module and of the outlet portion 28, the outlet portion 28 is configured to emit light in at least one favored overall direction P of emission. This direction P is, for example, inclined by an angle α with respect to the vertical (in the sense of the orientation of the vehicle, which corresponds to that of FIG. 4).

In order for some of the light traveling along the outlet portion 28 to be emitted toward the surface 9, the outlet portion 28 comprises deflection means 30 configured to deflect at least some of the light traveling along the outlet portion 28 toward the surface 9.

In the example of the figures, the deflection means 30 comprise one or more decoupling elements 32 formed in the surface of the outlet portion 28. Each decoupling element, also referred to as a deflection or decoupling prism, is designed to decouple out of the guide at least some of the light that is incident upon this decoupling element. Advantageously, they are arranged in a region of this surface which is oriented substantially away from the surface 9. In other words, they are arranged in a region of the surface of the outlet portion 28 opposite to the surface 9.

The decoupling elements 32 for example take the form of reliefs of chosen shape. The decoupling elements 32 are for example arranged to project with respect to the surface of the portion 28. Alternatively, they take the form of depressions.

The decoupling elements 32 for example adopt a corrugated overall shape. Alternatively, they take the overall shape of striations, or even of portions of the external surface of a torus.

The decoupling elements 32 are formed along the outlet portion 28.

The configuration of the decoupling elements, notably the location thereof within the outlet portion 28, is chosen so that, at the same time as the final orientation of the outlet portion 28 within the cavity 8, light is emitted by the outlet portion toward the surface 9. For this purpose they are, for example, created in the outlet portion at a face thereof opposite the surface 9.

Advantageously, the deflection means 30 comprise decoupling elements 32 over substantially the entire length of the outlet portion 28.

It will be noted that, advantageously, each decoupling element of the outlet portion is designed to decouple light in such a way as to respectively form, on the surface 9, an illuminated region having a given width along the outlet portion, the decoupling elements being designed so that the illuminated regions are contiguous and/or overlap one another.

Within the context of the invention, with reference to FIG. 3, aside from the elements described hereinabove, the guide 20 comprises an optical element 34.

The optical element 34 is configured to deflect, or decouple, some of the light propagating in the inlet portion 24 out of the guide and toward the surface 9.

Advantageously, the optical element is designed to decouple light in such a way as to form on the surface 9 an illuminated region of a width greater than the widths of the decoupling elements (along the outlet portion).

The optical element 34 is arranged in the region of the inlet portion 24. The optical element 34 is more specifically arranged so that it projects with respect to the inlet portion 24. Moreover, it extends in away from the inlet portion in the direction of the front wall 14.

With reference to FIG. 5, the optical element 34 is advantageously configured to emit light in a favored direction D of emission substantially parallel to the direction P.

With reference to FIGS. 5 and 6, the optical element 34 has the overall shape of a stud. It comprises a base 36, a reflection face 38 and an outlet face 40.

With reference to FIGS. 3 and 6, the base 36 has a portion 37 which forms a proximal end of the element 34 relative to the inlet portion 24. This portion 37 is configured to have a shape that complements the portion of the surface of the inlet portion in the region of which the optical element 34 is arranged.

In addition to this portion 37, the base 36 for example has a right prismatic or frustoconical overall shape.

For example, in the example of the figures, the base 36 has a frustoconical overall shape, disregarding the shaped portion 37.

The reflection face 38 lies in the continuation of the base 36. More specifically, the reflection face 38 is formed at the distal end of the base relative to the inlet portion. The external surface of the reflection face 38 faces away from the surface 9.

The reflection face 38 is configured to reflect the light that enters the optical element 34 toward the outlet face 40. Furthermore, it is configured so that the beam of light thus emanating from the optical element 34 illuminates a region Z (FIG. 2) of the surface 9 situated in line with the inlet portion 24 and that the deflection means 30 cannot illuminate satisfactorily. In practice, in the absence of the optical element according to the invention, this region Z is unilluminated or, at the very least, is illuminated differently from the rest of the surface 9, thus giving a result of nonuniform appearance.

To this end, the reflection face 38 is curved.

Advantageously, the reflection face 38 has the overall shape of a portion of the external surface of a torus. This geometric configuration has the effect of broadening the beam of light produced by the element 34 while at the same time making it possible to obtain uniform lighting power within this beam. This beam is advantageously centered on the direction D.

The outlet face 40 is opposite the reflection face 38. The outlet face 40 corresponds for example to a lower surface of the optical element 34 (within the sense of the orientation of the vehicle), it being appreciated that this orientation is liable to change according to the intended application. The outlet face 40 is oriented toward the surface 9. Advantageously, the outlet face 40 is substantially planar.

Advantageously, the optical element 34 is made from a material that is suitable for the light propagating within it to undergo total internal reflections at its interface with the outside environment. Furthermore, the optical element 34 advantageously has an optical index similar to the optical index of the material of the inlet portion 24. This encourages correct transmission of light between the inlet portion 24 and the optical element 34.

For example, the optical element 34 is made of PMMA or of PC.

Furthermore, the optical element 34 is advantageously formed as one with the inlet portion 24. Alternatively, the optical element 34 is not formed as one with the inlet portion. It is then for example attached thereto.

With reference to FIG. 3, the optical element 34 is also arranged on the inlet portion 24 at a location such that the photons emanating from the light source 18 and which have entered the light guide 20 cannot enter the optical element 34 without having undergone reflection within the guide.

In other words, the optical element 34 is advantageously situated at a location such that there is no direct optical path between the end of the inlet portion 24 coupled to the light source 18 and the optical element 34.

For example, for this purpose, the optical element 34 extends from the second sub-portion 24C from a region of this sub-portion that is closer to the outlet portion 28 than to the first sub-portion 241.

Furthermore, advantageously, as illustrated in FIG. 3, the optical element 34 extends in a direction that is inclined laterally with respect to a local plane L parallel to a plane X transverse to the outlet portion 28.

In other words, the optical element 34 extends in the direction of the front wall 14 but is inclined laterally relative to a configuration in which it would extend facing the front wall 14.

Advantageously, the optical element has a longitudinal dimension of less than 5 mm. For example, it is between 1111111 and 5 mm.

Furthermore, the angle between the axis of the element 34 and the axis along which the light propagates in the outlet portion 28 is advantageously between 45° and 90°.

One method for operating the lighting module will now be described with reference to the figures.

During an initial step, the light-emitting element is electrically powered by the substrate 22 so that the light source 18 emits light. Because it is optically coupled with the inlet portion 24, at least some of the light emitted enters the inlet portion 24.

Once inside the inlet portion 24, the light propagates in the inlet portion 24 toward the outlet portion 28, experiencing as appropriate one or more total reflections off the interface between the guide 20 and the external environment.

Some of the light which propagates in the inlet portion 24 enters the optical element 34. At least some of this light therefore reaches the reflection face 38. There it experiences reflection and is therefore deflected toward the outlet face 40 through which it passes toward the region Z of the surface 9. This region Z therefore appears illuminated.

Another part of the light that enters the inlet portion 24 reaches the outlet portion 28. For each decoupling element 32, part of the light that reaches as far as the decoupling element is deflected by the decoupling element 32 and is then deflected by the outlet portion toward the surface 9. Another part of the light propagates along the outlet portion 28 so that light reaches as far as each decoupling element and so that each decoupling element deflects part of the light toward the surface 9.

Thus, the surface 9 appears illuminated across its entire width.

A method of manufacturing the light guide 20 will now be described.

In a first alternative form in which the various elements of the guide 20 are formed as one with one another, the entirety of the light guide 20 is produced in one step. This step is, for example, performed by molding, or alternatively by machining.

In other words, the injection 24 and outlet 28 portions and the optical element 34 as well are manufactured as a single piece.

Alternatively, in a second embodiment in which at least one of the elements of the guide is not formed as one with the others, the elements that are formed as one with one another and which are formed as one with one another 20 are manufactured in a first step, and the other element or elements that are not formed as one with the other elements of the guide that are formed as one with one another are manufactured during a second step, for example likewise by molding.

During a third step, the various elements are then assembled with one another, for example by bonding or alternatively by overmolding.

The invention offers a number of advantages.

Specifically, the presence of the optical element has the effect of allowing some of the light that enters the inlet portion to be extracted. That makes it possible to compensate for the presence of potential dark regions within the lighting surface, and which are the result for example of a relative geometric layout of the inlet portion and of the outlet portion that does not allow the use of conventional deflection means in the region of the inlet portion in order to obtain a satisfactory result.

Furthermore, the optical element is itself relatively simple and inexpensive to manufacture, which means that the impact on the overall cost of the guide is only small.

Furthermore, the optical element is small in size, which means that the overall bulk of the light guide is not significantly affected by its presence.

Likewise, the absence of a direct optical path between the light source and the optical element has the effect that the light resulting from the presence of the optical element exhibits a high degree of uniformity with the light deflected by the deflection means, that the light emanating from the source 18 does not reach until after reflection. The lighting effect provided on the surface 9 by the lighting module is therefore indeed uniform.

1. Light guide for a lighting module, notably for a motor vehicle, the light guide being designed to guide light emanating from a light source within it, and comprising:
a bent inlet portion intended to be optically coupled to said light source for coupling light into the light guide,
an outlet portion optically coupled to the inlet portion and designed to decouple all or some of the light injected into the light guide,
wherein the inlet portion comprises an optical element configured to decouple part of the light passing into the inlet portion.

2. Light guide according to claim 1, wherein the inlet portion has an overall shape bent at 90°, or has a sub-portion having an overall shape bent at 90°.

3. Light guide according to claim 1, wherein the outlet portion is configured to radiate light in at least one favored overall direction (P) of emission, the optical element being configured to emit light in a favored direction (D) of emission parallel to said favored overall direction of emission.

4. Light guide according to claim 1, wherein the optical element is arranged on the inlet portion at a suitable location such that the light emanating from the light source and entering the optical element undergoes at least one reflection within the light guide.

5. Light guide according to claim 1, wherein the optical element has a reflection face configured to reflect at least part of the light that enters the optical element.

6. Light guide according to claim 5, wherein the reflection face is curved.

7. Light guide according to claim 5, wherein the reflection face has the overall shape of a portion of the external surface of a torus.

8. Light guide according to claim 1, wherein the optical element has a base of right prismatic or frustoconical overall shape comprising a portion configured to exhibit a shape that complements a surface of the inlet portion at which the optical element is arranged.

9. Light guide according to claim 1, wherein the optical element is made from a material having an optical index substantially identical to the optical index of the inlet portion.

10. Light guide according to claim 1, wherein the optical element is formed as one with the inlet portion.

11. Light guide according to claim 1, wherein the optical element is fixed to the inlet portion.

12. Light guide according to claim 1, wherein the outlet portion comprises deflection means configured to decouple some of the light spreading in the outlet portion for the radiation of said outlet portion.

13. Lighting module for illuminating the inside of a motor vehicle interior, the lighting module comprising:
a light guide according to any one of the preceding claims, and
a light source optically coupled to the inlet portion of the light guide.

14. Instrument panel, notably of a motor vehicle, wherein the panel comprises a cavity, a surface and a lighting module according to claim 13 arranged at least partially in the cavity and configured to illuminate said surface.

15. Light guide according to claim 2, wherein the outlet portion is configured to radiate light in at least one favored overall direction (P) of emission, the optical element being configured to emit light in a favored direction (D) of emission parallel to said favored overall direction of emission.

16. Light guide according to claim 2, wherein the optical element is arranged on the inlet portion at a suitable location such that the light emanating from the light source and entering the optical element undergoes at least one reflection within the light guide.

17. Light guide according to claim 2, wherein the optical element has a reflection face configured to reflect at least part of the light that enters the optical element.

18. Light guide according to claim 6, wherein the reflection face has the overall shape of a portion of the external surface of a torus.

19. Light guide according to claim 2, wherein the optical element has a base of right prismatic or frustoconical overall shape comprising a portion configured to exhibit a shape that complements a surface of the inlet portion at which the optical element is arranged.

20. Light guide according to claim 2, wherein the optical element is made from a material having an optical index substantially identical to the optical index of the inlet portion.
